(19) United States
(12) Patent Application Publication
(10) Pub. No.: US 2023/0357648 A1
(43) Pub. Date: Nov. 9, 2023

(54) Lipid-Assisted Conversion

(71) Applicant: Renewable Energy Group, Inc., Ames, IA (US)

(72) Inventors: David Slade, Ames, IA (US); Ramin Abhari, Bixby, OK (US); Martin Haverly, Ames, IA (US)

(73) Assignee: Renewable Energy Group, Inc, Ames, IA (US)

(21) Appl. No.: 18/312,814

(22) Filed: May 5, 2023

Related U.S. Application Data
(60) Provisional application No. 63/339,260, filed on May 6, 2022.

(51) Int. Cl. C10G 3/00; C10G 7/00

(52) U.S. Cl. CPC C10G 3/50; C10G 7/00; C10G 3/46; C10G 2400/02; C10G 2400/04; C10G 2300/203; C10G 2300/1014; C10G 2300/1018; C10G 2300/4006; C10G 2300/4012; C10G 2300/307

(57) ABSTRACT

A method for converting a bio-oil derived from lignocellulosic biomass to a fuel or fuel blendstock. The method may include contacting the bio-oil with a lipid or lipid derivative to form an organic phase comprising phenolic compounds and an aqueous phase. The organic phase is separated from the aqueous phase and subjected to hydrogenation and deoxygenation in a hydroprocessing reactor to produce a hydrocarbon product, a gas product, and water. The hydroprocessing reactor hydrocarbon product is fractionated into fuel products comprising gasoline and kerosene/diesel.

### CROSS-REFERENCE TO RELATED APPLICATION

The present application claims priority from U.S. Provisional Application No. 63/339,260 filed May 6, 2022, which is incorporated herein by reference in its entirety.

### FIELD OF THE INVENTION

The present technology relates generally to hydrocarbon fuels and more specifically to fuels having a renewable content. More particularly, the technology relates to upgrading pyrolysis bio-oil fractions to premium fuels via hydroprocessing.

### BACKGROUND OF THE INVENTION

As a renewable alternative to fossil fuels, biofuels have been embraced by consumers and policy makers alike as a potential key component of societal as well as governmental climate change mitigation strategies. However, most biofuels used today are based on either sugar or lipid feedstocks. Long term growth of the biofuel industry requires diversification to more abundant lignocellulosic feedstocks such as woody biomass.

Upgrading biomass to premium hydrocarbon fuels such as renewable diesel requires additional processing such as hydroprocessing. Since most hydrogen is still generated from steam reforming of fossil fuels, there is an incentive to minimize hydrogen consumption during the hydroprocessing phase(s).

Lignocellulose biomass includes cellulose, hemicellulose, and lignin. Each of these constituents is a polymer with different building blocks, as shown in FIG. 1. Bio-oils are formed by depolymerization of these macromolecules, typically via thermochemical reactions as disclosed in the prior art. One such process is pyrolysis. Pyrolysis generally refers to high temperature conversion of carbonaceous feedstock (typically solids) into primarily liquids. In order to prevent combustion, pyrolysis is conducted in near or total absence of diatomic oxygen. In addition to liquids, pyrolysis products from lignocellulosic biomass include gas (mainly CO, CO₂, hydrogen, and non-condensable hydrocarbons) and char (a carbon-rich solid). The liquid product, referred to as pyrolytic oil or bio-oil, typically includes the following:
(1) C2-C4 oxygenates formed by fragmentation of cellulose and hemicellulose; these include hydroxyacetaldehyde, acetal, and acetic acid and make up 8-26% of the bio-oil;
(2) Mono-phenols formed by depolymerization of lignin; these may also contain small quantities of furans and make up 2-7% of the bio-oil;
(3) Lignin-derived oligomers (a.k.a. “pyrolytic lignin”) which are water-insoluble and make up 15-25% of the oil; and
(4) Sugars and anhydrosugars formed by fragmentation of cellulose and hemicellulose which are typically water soluble and form 10-20% of the bio-oil.

Bio-oil further includes water, which makes up about 14 to 30% of its mass by weight. Commonly, the bio-oil water is present as part of a stable emulsion. On a dry basis, bio-oil contains around 38 to 44% oxygen.

In some pyrolysis processes, the condensable (i.e., liquid) products can be selectively recovered as fractions according, primarily, to their boiling points. In one such embodiment, the fractions can generally be achieved so that the water and C2-C4 oxygenates, mono-phenols, and lignin-derived oligomers and sugars can be recovered separately.

In some pyrolysis processes, the gaseous and the solid products are combusted to fuel the endothermic pyrolytic reactions.

Pyrolysis processes may be designed to occur at a variety of conditions; such as temperature, residence time, reaction medium, and optional catalyst selection as examples and can all be highly variable. Fast pyrolysis occurs at higher temperatures (>900° F. compared to 750-950° F. for slow pyrolysis) and can be the preferred process for maximizing bio-oil yield.

Pyrolysis may be conducted in a number of reactor configurations. One common fast pyrolysis system includes the use of fluidized bed reactors over inert or catalytic solid particles. The fluidization gas may be nitrogen, or as in some embodiments, the gas produced by pyrolysis itself (e.g., recycled through a booster compressor). During pyrolysis of wood chips, the ground wood is intimately contacted with hot solid particles within the fluidized bed. As the wood undergoes fast pyrolysis, the solid particles become coated with char. These solid particles are subsequently regenerated by char or coke burn-off in a different vessel. The heat of the char combustion supplies the heat for the endothermic pyrolysis reaction as the hot regenerated solid particles are returned to the reactor. In most such pyrolysis reactor systems, the ground biomass is fed continuously to the pyrolysis reactor as the solid particles circulate between the reactor and regenerator.

Pyrolysis may also be conducted in a liquid reaction medium in a process called “solvent liquefaction.” Solvent liquefaction is typically conducted as either a batch or continuous process in one or multiple liquid slurry reactor(s). The solvent can be chosen to enhance the process chemistry, or for more practical reasons such as choosing water as the solvent to process wet feedstocks. Typically, solvent liquefaction involves mixing biomass with a solvent in a slurry reactor at temperatures between about 300 to 700° F. and at pressures ranging from around 1 to 3000 psi. Residence times in the slurry reactor can vary substantially, but generally range from around 1 to 60 minutes. Gases and vapors can be allowed to vent off the top of the slurry reactor while the solids and some portions of the liquid products are directed out of the reactor through a solids removal step. Condensable vapors and liquid products are then further processed and, often, fractionated, to recover some portion of the solvent for recycling to the front of the process.

It is often difficult to prevent polymerization of the reactive compounds found in the bio-oil. The lignin-derived liquids can be particularly susceptible to polymerization. This causes processing, storage, transport, and usage issues with the produced bio-oil.

Certain bio-oil streams can be mildly hydrogenated to improve stability and partially mitigate undesired polymerization reactions prior to and in pursuit of more thorough or complete hydroprocessing.

In order to be useful as drop-in fuel blendstocks, bio-oils need to be hydrotreated, mainly to deoxygenate the oil. However, hydrotreating of bio-oils has many unresolved challenges. These include poor deoxygenation performance and high heat release. Diluting the bio-oil in hydrocarbons to address these issues is not practical since bio-oils do not form a homogenous solution in most hydrocarbons (including petroleum middle distillates).

The prior art describes production of paraffinic hydrocarbon fuels via hydroprocessing of lipids, including co-hydroprocessing of lipids with petroleum fractions. A few publications report parameters that define optimum conditions for co-hydroprocessing of straight-run diesel or gasoil with lipids. Co-hydroprocessing with 10% and 20% rapeseed oil with straight-run diesel/light gas oil has been described by Jerzy Walendziewski and co-workers (Fuel Processing Technology 90, 2009, 686-691). In a more recent study, P. Dhar and co-workers report co-processing of 5-15% palm and jatropha oils with straight-run gas oil (Hydrocarbon Processing, January 2018; 25-28). These studies broadly describe the conversion chemistry of lipids with mainly C16 and C18 fatty acids to n-paraffins in the C15-C18 range and highlight the deterioration of the treated diesel low-temperature properties (i.e., cloud point, CFPP, pour point) with increase in feed lipid content.

Publications, patents and patent applications are referred to throughout this disclosure. All references cited herein are hereby incorporated by reference.

In a paper titled “Hydrotreating in the production of green diesel” (PTQ, Q2; 2010), Rasmus Egeberg and co-workers provide a case history for the conversion of a straight-run light gas oil mild hydrocracking unit into a hydrotreater for co-processing up to 30% raw tall diesel (FAME produced from tall oil) with straight-run middle distillates. This paper also describes a multi-bed diesel hydrotreater wherein a bottom bed of dewaxing catalyst is used to hydrocrack/isomerize the straight-chain paraffin products of lipid hydrotreating, thus improving the co-processed diesel's low-temperature properties.

To summarize, the prior art teaches co-hydroprocessing of lipids and lipid-derivatives with straight-run petroleum fractions. However, methods for advantageous co-hydroprocessing of lipids with bio-oil fractions from pyrolysis/liquefaction of lignocellulosic biomass have not been previously described in the prior art. There thus remains an unmet need for enhancing biofuel feedstock diversity and fuel properties.

### SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

An aspect of the invention involves contacting bio-oils derived from lignocellulose biomass with lipids (or lipid derivatives such as biodiesel, as well as biodiesel production and vegetable oil processing co-products) in order to (1) recover the higher carbon-content bio-oil components, (2) improve the stability of the bio-oil, (3) improve its miscibility with hydrocarbons, and (4) upgrade the bio-oils through hydroprocessing reactors. Depending on the pyrolysis process and bio-oil properties, the contacting may be performed at various points or stages in the bio-oil production and refining process. The hydroprocessed fuel fractions of the invention have advantages over conventional paraffinic renewable diesel, renewable paraffinic kerosene, and renewable gasoline/naphtha due to the presence of multicyclic, naphthenic, and aromatic hydrocarbons. For diesel fuels, such advantages include better solubility of lower-quality (e.g., non-distilled) biodiesel when producing 100% renewable fuel blends that include biodiesel. For gasoline or naphtha, the advantages include for example, a better octane rating. For kerosene, the advantages include the presence of aromatics which are required in the specifications or standards for use as jet fuel see for example ASTM D1655 and D7566, and a reduction in the freezing point. One aspect of the present invention involves the co-hydroprocessing of bio-oils with an effective H/C ratio of 0.3-1.0 with lipids having an effective H/C ratio of 1.5-2.0 thereby reducing the hydrogen consumption requirements and processing challenges for upgrading bio-oils into premium hydrocarbon fuels characterized by high H/C ratio.

In one exemplary embodiment of the present invention, a method for converting a bio-oil derived from lignocellulosic biomass to a fuel or fuel blendstock is described and includes the steps of initially contacting the bio-oil with a lipid or lipid derivative to form an organic phase comprising phenolic compounds and an aqueous phase. Next, the organic phase is separated from the aqueous phase and then the organic phase is subjected to hydrogenation and deoxygenation in a hydroprocessing reactor to produce a hydrocarbon product, a gas product, and water, and then fractionating the hydroprocessing reactor hydrocarbon product into fuel products comprising gasoline and kerosene/diesel.

In a still further exemplary embodiment of the present invention a method for converting a bio-oil derived from lignocellulose biomass to a hydrocarbon fuel or fuel blendstock is provided and includes the steps of initially, combining the bio-oil with a lipid to produce a combined feed and then directing the combined feed to a hydroprocessing reactor to produce a reactor effluent. Next, the reactor effluent is separated into a hydrocarbon, a gas, and a water stream, and then fractionating the hydrocarbon into a gasoline cut and a kerosene/diesel cut. The combined feed has a lipid content between about 16 vol. % and about 90 vol. % and the kerosene/diesel cut has less than 0.1 wt. % oxygen.

In a yet still further exemplary embodiment of the present invention hydrocarbon fuel or blend stock, is described and includes a bio-oil with a lipid to produce a combined feed. A reactor effluent produced by subjecting the combined feed to a hydroprocessing reactor which is separated into a hydrocarbon, a gas, and a water stream. A gasoline cut and a kerosene/diesel cut, wherein the combined feed has a lipid content between about 16 vol. % and about 90 vol. % and the kerosene/diesel cut has less than 0.1 wt. % oxygen.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the exemplary embodiments of the invention in conjunction with the accompanying drawings, of which:

FIG. 1 is a representation of the polymeric building blocks of lignocellulose biomass;

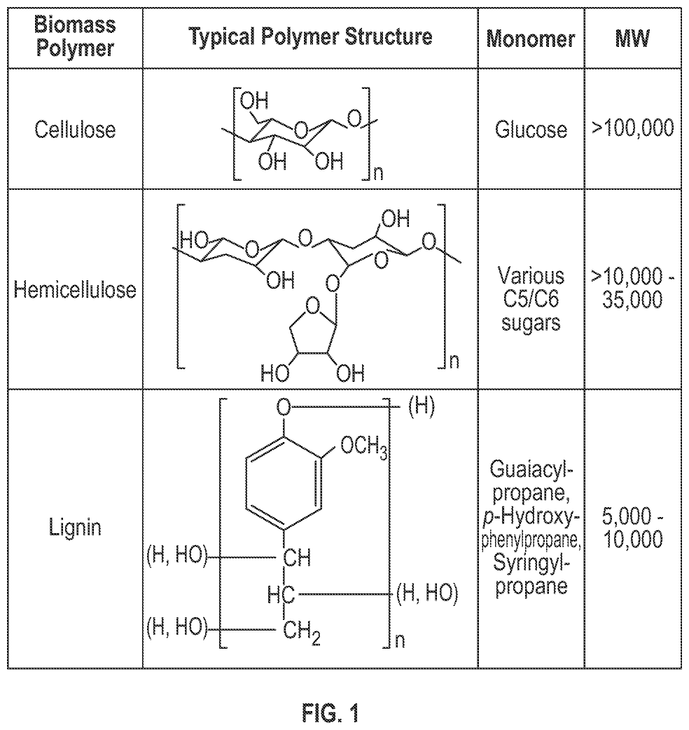

FIG. 2 is a block diagram of a process flow for an embodiment of the present invention;

FIG. 3 is a schematic diagram of a process flow of an alternate embodiment of the present invention;

FIG. 4 is a plot of HDO product TAN as a function of the amount of lipid in bio-oil; and

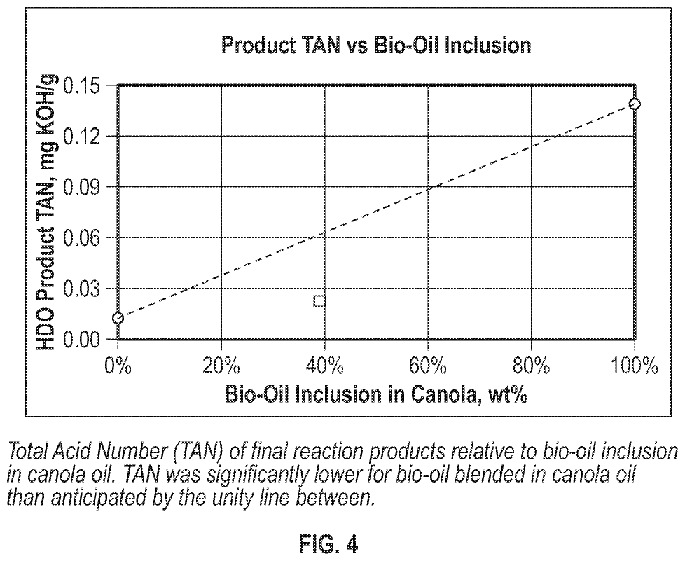

FIG. 5 is a plot of HDO liquid yield as a function of the amount of lipid in bio-oil;

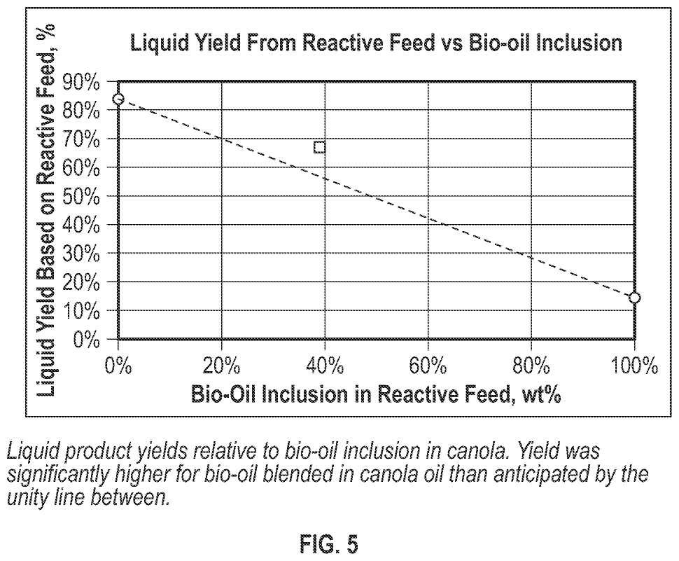

### DETAILED DESCRIPTION OF THE INVENTION

The apparatuses and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to FIGURES.

As used herein, “about”, “around” or “approximately” will mean up to plus or minus 10% of the particular term. The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “alkyl” groups include straight chain and branched alkyl groups. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. It will be understood that the phrase “Cᵢ-Cⱼ alkyl,” such as C₁-C₄ alkyl, means an alkyl group with a carbon number falling in the range from i to j.

The term “aromatics” as used herein is synonymous with “aromates” and means both cyclic aromatic hydrocarbons that do not contain heteroatoms as well as heterocyclic aromatic compounds. The term includes monocyclic, bicyclic and polycyclic ring systems. The term also includes aromatic species with alkyl groups and cycloalkyl groups. Thus, aromatics include, but are not limited to, benzene, azulene, heptalene, phenylbenzene, indacene, fluorene, phenanthrene, triphenylene, pyrene, naphthacene, chrysene, anthracene, indene, indane, pentalene, and naphthalene, as well as alkyl and cycloalkyl substituted variants of these compounds. In some embodiments, aromatic species contains between 6 and 14 carbons, and in others from 6 to 12 or even 6 to 10 carbon atoms in the ring portions of the groups. The phrase includes groups containing fused rings, such as fused aromatic-aliphatic ring systems (e.g., indane, tetrahydronaphthene, and the like).

“Oxygenates” or an “oxygenated hydrocarbon” as used herein means carbon-containing compounds containing at least one covalent bond to oxygen. Examples of functional groups encompassed by the term include, but are not limited to, carboxylic acids/esters, carboxylates, acid anhydrides, aldehydes, esters, ethers, ketones, and alcohols. Oxygenates may also be oxygen containing variants of aromatics, cycloparaffins, and paraffins as described herein. Fatty acids or glycerides are naturally occurring carboxylic acids or esters that define lipids.

The term “paraffins” as used herein means non-cyclic, branched or unbranched alkanes. An unbranched paraffin is an n-paraffin; a branched paraffin is an iso-paraffin. “Cycloparaffins” are cyclic, branched or unbranched alkanes.

The term “paraffinic” as used herein means both paraffins and cycloparaffins as defined above as well as predominantly hydrocarbon chains possessing regions that are alkane, either branched or unbranched.

The term “olefin” as used herein means non-cyclic, branched or unbranched alkenes. The term “olefinic” as used herein means both mono- or di-unsated (i.e., one or two double bonds) hydrocarbons, either cyclic, branched or unbranched.

Hydroprocessing as used herein describes the various types of catalytic reactions that occur in the presence of hydrogen without limitation. Examples of the most common hydroprocessing reactions include, but are not limited to, hydrogenation, hydrodesulfurization (HDS), hydrodenitrogenation (HDN), hydrotreating (HT), hydrocracking (HC), aromatic saturation or hydrodearomatization (HDA), hydrodeoxygenation (HDO), decarboxylation (DCO), hydroisomerization (HI), hydrodewaxing (HDW), hydrodemetallization (HDM), decarbonylation, methanation, and reforming. Depending upon the type of catalyst, reactor configuration, reactor conditions, and feedstock composition, multiple reactions can take place that range from purely thermal (i.e., do not require catalyst) to catalytic. In the case of describing the main function of a particular hydroprocessing unit, for example an HDO reaction system, it is understood that the HDO reaction is merely one of the predominant reactions that are taking place and that other reactions may also take place.

Decarboxylation (DCO) is understood to mean hydroprocessing of an organic molecule such that a carboxyl group is removed from the organic molecule to produce CO₂, as well as decarbonylation which results in the formation of CO.

Pyrolysis is understood to mean thermochemical decomposition of carbonaceous material with little to no diatomic oxygen or diatomic hydrogen present during the thermochemical reaction. The product fractions obtained by pyrolysis are referred to as pyrolyzates.

Hydrotreating (HT) involves the removal of elements from groups IIIa, Va, VIa, and/or VIIa of the Periodic Table from organic compounds. Hydrotreating may also include hydrodemetallization (HDM) reactions. Hydrotreating thus involves removal of heteroatoms such as oxygen, nitrogen, sulfur, and combinations of any two more thereof through hydroprocessing. For example, hydrodeoxygenation (HDO) is understood to mean removal of oxygen by a catalytic hydroprocessing reaction to produce water as a by-product; similarly, hydrodesulfurization (HDS) and hydrodenitrogenation (HDN) describe the respective removal of the indicated elements through hydroprocessing. Since the main heteroatom removed during hydrotreatment of biological feedstocks is oxygen, the term hydrodeoxygenation or HDO is used interchangeably with hydrotreating in this disclosure.

Hydrogenation involves the addition of hydrogen to an organic molecule without breaking the molecule into subunits. Addition of hydrogen to a carbon-carbon or carbon-oxygen double bond to produce single bonds are two nonlimiting examples of hydrogenation. Partial hydrogenation and selective hydrogenation are terms used to refer to hydrogenation reactions that result in partial saturation of an unsaturated feedstock. For example, vegetable oils with a high percentage of polyunsaturated fatty acids (e.g., linoleic acid) may undergo partial hydrogenation to provide a hydroprocessed product wherein the polyunsaturated fatty acids are converted to mono-unsaturated fatty acids (e.g., oleic acid) without increasing the percentage of undesired saturated fatty acids (e.g., stearic acid). While hydrogenation is distinct from hydrotreatment, hydroisomerization, and hydrocracking, hydrogenation may occur amidst these other reactions.

Hydrocracking (HC) is understood to mean the breaking of a molecule's carbon-carbon bond to form at least two molecules in the presence of hydrogen. Such reactions typically undergo subsequent hydrogenation of the resulting double bond.

Hydroisomerization (HI) is defined as the skeletal rearrangement of carbon-carbon bonds in the presence of hydrogen to form an isomer. Hydrocracking is a competing reaction for most HI catalytic reactions and it is understood that the HC reaction pathway, as a minor reaction, is included in the use of the term HI. Hydrodewaxing (HDW) is a specific form of hydrocracking and hydroisomerization designed to improve the low temperature characteristics of a hydrocarbon fluid.

It will be understood that if a composition is stated to include “Cᵢ-Cⱼ hydrocarbons,” such as C₇-C₁₂ n-paraffins, this means the composition includes one or more paraffins with a carbon number falling in the range from i to j.

A “middle distillate” in general refers to a petroleum fraction in the range of about 200° F. (93° C.) to about 800° F. (427° C.). This includes kerosene (about 200-520° F.), diesel and light gasoil (about 400 to 650° F.), and heavy gasoil (about 610-800° F.).

A “lipid” as used herein refers to fats, oils, and greases and fractions thereof. Lipids primarily include saturated and unsaturated fatty acids in the C8-C24 range, in which the fatty acids can be in the form of esters of glycerin (i.e. as mono-, di-, and triglycerides) or as free fatty acids (FFA). Lipids may also include minority constituents such as fats or oils like sterols, steryl esters, steryl glucosides, terpenes, tocopherols, vitamins, proteins, waxes, and others.

Hydrogen-Carbon mole ratio, or “H/C ratio” for short, refers to the mole ratio of hydrogen to carbon (i.e., the ratio of hydrogen atoms to carbon atoms) in a compound, a simple composition of several compounds, or a complex composition of many compounds. For hydrocarbons containing heteroatoms, including oxygenates, the effective H/C ratio, H/C_{eff}, may be calculated from its empirical formula or its CHNOS molar composition according to Eq. 1 shown below.

H/C_{eff}=(H-2O-3N-2S)/C

For a hydrocarbon free of N, O, and S heteroatoms, the above equation reduces to H/C. However, for an oxygenate like a lipid (where the fatty acids can be regarded as straight-chain hydrocarbons terminating with a carboxyl group), Eq. 1 expresses the H/C ratio on an oxygen-free basis by considering the chemically dehydrated form of the oxygenate (wherein each oxygen atom is removed with two of the oxygenated hydrocarbon's hydrogen atoms).

The empirical formula of mixture of hydrocarbons, or hydrocarbons and oxygenates, may be determined mathematically by knowing the blend composition, or analytically by various ultimate analysis techniques or via ASTM D5291 analysis. In either case, knowing C, H, N, O, and S values for the complex composition, the H/C_{eff} value may be calculated according to Eq. 1.

It should be understood that a “volume percent” or “vol. %” of a component in a composition or a volume ratio of different components in a composition is determined at room temperature (about 23° C.) based on the initial volume of each individual component, not the final volume of combined components.

The Present Technology

In one respect, a method is provided to produce high H/C ratio hydrocarbon fuels from low H/C ratio lignocellulose bio-oils. The increase in H/C ratio is achieved by co-processing the bio-oil with a lipid. Tables I and II provide typical effective H/C ratios for lipids and lignocellulose bio-oils, respectively. As observed from these tables, lipids typically have effective H/C ratios in the 1.5 to 1.7 range, whereas the lignocellulose bio-oils have effective H/C ratios of 1 or less, typically in the 0.2 to 1.0 range, and often in the 0.0 to 1.0 range.

TABLE I
Common lipid feedstocks and corresponding
Hydogen-Carbon Ratios

| | Triglyceride Empricial Formula* | | | H/C Ratio |
|---|---|---|---|---|
| Feedstock | C | H | O | from Eq 1 |
| Beef Tallow | 54.8 | 102.3 | 6 | 1.65 |
| Canola Oil | 56.9 | 101.9 | 6 | 1.58 |
| Choice White Grease | 55.4 | 101.8 | 6 | 1.62 |
| Corn Oil | 56.0 | 99.3 | 6 | 1.56 |
| Palm Oil | 54.3 | 101.0 | 6 | 1.64 |
| Poultry Fat | 55.7 | 100.9 | 6 | 1.60 |
| Soybean Oil | 56.5 | 99.4 | 6 | 1.55 |
| Used Cooking Oil | 56.4 | 99.9 | 6 | 1.56 |
| Yellow Grease | 56.1 | 101.0 | 6 | 1.59 |

*Based on published fatty acid profiles

TABLE II
Typical components in lignocellulose bio-oil

| | | Formula | | | H/C ratio |
|---|---|---|---|---|---|
| No. | Common Name | C | H | O | (Eq 1) |
| 1 | methyl-cyclohexeneone | 6 | 8 | 1 | 1.0 |
| 2 | 5-methyl-2-furaldehyde | 6 | 6 | 2 | 0.33 |
| 3 | phenol | 6 | 6 | 1 | 0.67 |
| 4 | cresol isomers | 7 | 8 | 1 | 0.86 |
| 5 | guaiacol | 7 | 8 | 2 | 0.57 |
| 6 | methyl-guaiacol | 8 | 10 | 2 | 0.75 |
| 7 | 2-ethylphenol | 8 | 10 | 1 | 1.00 |
| 8 | Syringol | 8 | 10 | 3 | 0.50 |
| 9 | Vanillin | 8 | 8 | 3 | 0.25 |
| 10 | Levoglucosan | 6 | 10 | 5 | 0.00 |
| 11 | Furfural | 5 | 4 | 2 | 0.00 |
| 12 | Acetic Acid | 2 | 4 | 2 | 0.00 |

The method includes the steps of initially contacting a bio-oil (e.g. pyrolyzate) with a lipid and subjecting the mixed stream to a temperature, a hydrogen pressure, and a catalyst, to produce a hydrocarbon having a higher effective H/C ratio than the bio-oil. In additional embodiments, the bio-oil and the lipid are diluted with a hydrocarbon diluent substantially free of olefins.

Exemplary bio-oil feedstock include, but are not limited to, bio-oil and bio-oil fractions produced by fast pyrolysis, solvent liquefaction, hydrothermal liquefaction, and catalytic cracking of carbonaceous feedstocks. Carbonaceous feedstocks include, but are not limited to, coal, crude petroleum, petroleum fractions, municipal solid waste, plastic waste, segregated solid waste, food waste, sewer sludge, manure, forestry residues (e.g., tree thinnings, sawdust, wood chips, etc.), renewable fuel residues, used filter media, pulp and paper residues (e.g., black liquor), agricultural residues (e.g., corn stover, bean stover, sugar cane bagasse, etc.), herbaceous energy crops (e.g., switchgrass, miscanthus, etc.), woody energy crops (e.g., hybrid poplar, southern yellow pine, etc.), aquatic energy crops (e.g., algae, seaweed, etc.), and mixtures of any two or more thereof.

Exemplary lipid feedstock include, but are not limited to, an animal fat, animal oil, microbial oil, plant fat, plant oil, vegetable fat, vegetable oil, grease, or a mixture of any two or more thereof. Plant and/or vegetable oils and/or microbial oils include, but are not limited to, corn oil, distiller's corn oil, inedible corn oil, babassu oil, carinata oil, soybean oil, canola oil, coconut oil, rapeseed oil, tall oil, tall oil fatty acid, palm oil, palm oil fatty acid distillate, palm sludge oil, jatropha oil, palm kernel oil, pennycress oil, sunflower oil, castor oil, camelina oil, archaeal oil, bacterial oil, fungal oil, protozoal oil, algal oil, seaweed oil, oils from halophiles, and mixtures of any two or more thereof. These may be classified as crude, degummed, and RBD (refined, bleached, and deodorized) grade, depending on level of pretreatment and residual phosphorus and metals content. However, any of these grades may be used in the present technology. Animal fats and/or oils as used above includes, but is not limited to, inedible tallow, edible tallow, technical tallow, floatation tallow, bleachable fancy tallow, lard, technical lard, choice white grease, poultry fat, poultry oils, fish fat, fish oils, and mixtures of any two or more thereof. Greases may include, but are not limited to, yellow grease, brown grease, waste vegetable oils, restaurant greases, trap grease from municipalities such as water treatment facilities, and spent oils from industrial packaged food operations, and mixtures of any two or more thereof. Depending on level of pretreatment, such biorenewable lipid feedstock may contain between about 1 wppm and about 800 wppm phosphorus, and between about 1 wppm and about 400 wppm total metals (mainly sodium, potassium, magnesium, calcium, iron, and copper). The lipid may also contain up to 100 wt. % free fatty acid. The lipid may include about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80% wt. %, about 85% wt. %, about 90% wt. %, about 95% wt. %, or any range including and/or in between any two of these values or other combinations of these values.

Thus, the lipid feedstock of any embodiment herein may include corn oil, inedible corn oil, distiller's corn oil, babassu oil, carinata oil, soybean oil, canola oil, coconut oil, rapeseed oil, tall oil, tall oil fatty acid, palm oil, palm oil fatty acid distillate, palm sludge oil, jatropha oil, palm kernel oil, pennycress oil, sunflower oil, castor oil, camelina oil, archaeal oil, bacterial oil, fungal oil, protozoal oil, algal oil, seaweed oil, oils from halophiles, rendered fats, inedible tallow, edible tallow, technical tallow, floatation tallow, bleachable fancy tallow, lard, technical lard, choice white grease, poultry fat, poultry oils, fish fat, fish oils, frying oils, yellow grease, brown grease, waste vegetable oils, restaurant greases, trap grease from municipalities such as water treatment facilities, and spent oils from industrial packaged food operations, or a mixture of any two or more thereof. In embodiments, derivatives of such lipids, such as alkyl esters formed via transesterification or esterification of the lipid with an alcohol, may be used instead of the lipid. Examples include fatty acid methyl esters (FAME), the most common type of biodiesel. Other derivatives include free fatty acids (FFA) formed by hydrolysis of the lipid, or FAME produced by esterification of the FFA with methanol.

### Co-Hydroprocessing Embodiment

The amount of lipid on a lipid plus bio-oil basis is between about 16 vol. % and about 90 vol. %. The concentration on the lipid plus bio-oil basis may be about 18 vol. %, about 20 vol.

%, about 22 vol. %, about 24 vol. %, about 26 vol. %, about 28 vol. %, about 30 vol. %, about 32 vol. %, about 34 vol. %, about 36 vol. %, about 38 vol. %, about 40 vol. %, about 42 vol. %, about 44 vol. %, about 46 vol. %, about 48 vol. %, about 50 vol. %, about 52 vol. %, about 54 vol. %, about 56 vol. %, about 58 vol. %, about 60 vol. %, about 62 vol. %, about 64 vol. %, about 66 vol. %, about 68 vol. %, about 70 vol. %, about 72 vol. %, about 74 vol. %, about 76 vol. %, about 78 vol. %, about 80 vol. %, about 82 vol. %, about 88 vol. %, or any range including and/or in between any two of these values or combination of these values.

The volumetric ratio of lipid plus bio-oil to optional diluent is between 1:1 and 1:9. The ratio of lipid plus bio-oil to diluent may be about 1:2, about 1:3, about 1:4, about 1:5, about 1:6, 1:7, and 1:8, or any range including and/or in between any two of these values or combination of these values.

In any embodiment herein the lipid and bio-oil feedstocks are hydrotreated as a combined hydrotreater feed and optionally subsequently hydrocracked and/or hydroisomerized. The effective H/C ratio of the combined feed of lipid and bio-oil is greater than 1.40. The effective H/C ratio of the combined feed may be about 1.45, about 1.50, about 1.55, about 1.60, about 1.65, about 1.70, about 1.75, about 1.80, about 1.85, about 1.90, and about 1.95, or any range including and/or in between any two of these values. For example, the effective H/C ratio of the combined feed of lipid and bio-oil is between 1.55 and 1.85.

In the present technology the combined feed is subjected to hydrotreatment in the presence of hydrogen over sulfided forms of hydrogenation metals from Group VIB and Group VIII of the periodic table. Examples of suitable mono-metallic, bi-metallic, and tri-metallic catalysts include Mo, Ni, Co, W, CoMo, NiMo, NiW, NiCoMo. These catalysts may be supported on alumina, or alumina modified with oxides of silicon and/or phosphorus. These catalysts may be purchased in the reduced sulfide form, or more commonly purchased as metal oxides and sulfided during startup. The hydrotreatment is performed at a temperature falling in the range from about 480° F. (250° C.) to about 700° F. (370° C.) WABT and at a pressure from about 1000 psig (69 barg) to about 4,000 psig (275 barg). WABT or weighted average bed temperature is commonly used in fixed bed, adiabatic reactors to express the “average” temperature of the reactor which accounts for the nonlinear temperature profile between the inlet and outlet of the reactor.

$$WABT = {\sum }_{i = 1}^{N} ( {WABT}_{i} ) ( {Wc}_{i} ) \\ {WABT}_{i} = \frac{{T}_{i}^{in} + 2 {T}_{i}^{out}}{3}$$

In the equation above, Tᵢⁱⁿ and Tᵢ^{out} refer to the temperature at the inlet and outlet, respectively, of catalyst bed i. As shown, the WABT of a reactor system with N different catalyst beds may be calculated using the WABT of each bed (WABTᵢ) and the weight of catalyst in each bed (Wcᵢ) Preferred hydrotreater WABT and pressure ranges for the present technology are 550-690° F. and 1,000-3,000 psig.

Hydrodeoxygenation of pyrolysis bio-oils typically requires significantly higher hydrotreater temperatures, with WABT values about 700° F. or higher. This is mainly due to presence of more refractory oxygen compounds such as phenols and guaiacols. Operating at such high temperatures results in an increase in product aromatic content. The increase in aromatics is due to the hydrogenation-dehydrogenation equilibrium which favors hydrogenation at lower temperatures (less than about 690° F.) and dehydrogenation (higher aromatics) at high temperatures (greater than about 690° F.). Higher aromatic content translates to reduction in cetane number of the diesel product and increased rates of catalyst carbon buildup. In the present technology, a surprisingly lower hydrotreater temperature is required to reach deoxygenation. Due to the lower temperatures, a more complete aromatic saturation is achieved.

The kerosene/diesel fraction of the product of lipid and bio-oil co-hydroprocessing (that is, the hydrocarbon product in the kerosene and/or diesel boiling range, and abbreviated as kero/diesel) according to any embodiment of this invention has an oxygen content less than about 0.1 wt. %. The kero/diesel fraction may have an oxygen content of about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, about 0.1 wt. %, or any range including and/or in between any two of these values or below any one of these values or combination of these values. Such low values of oxygen can be detected through appropriate analytical techniques, including but not limited to Fast Neutron Activation Analysis or Instrumental Neutron Activation Analysis.

In any embodiment herein, the kero/diesel fraction of the product of lipid and bio-oil co-hydroprocessing according to this invention has a cetane number greater than about 40. The kero/diesel fraction may have a cetane number of about 42, about 44, about 46, about 48, about 50, about 52, about 54, about 56, about 58, about 60, about 62, about 64, about 66, about 68, about 70, about 80, or any range including and/or in between any two of these values or above any one of these values or combination of these values.

The kero/diesel fraction of the product of lipid and bio-oil co-hydroprocessing according to this invention typically has a 60° F. density less than about 0.88 kg/L, and may have a density of about 0.86 kg/L, about 0.85 kg/L, about 0.84 kg/L, about 0.83 kg/L, about 0.82 kg/L, about 0.81 kg/L, about 0.80 kg/L, about 0.79 kg/L, about 0.78 kg/L, or any range including and/or in between any two of these values or less than any one of these values or combination of these values.

The kero/diesel fraction of the product of lipid and bio-oil co-hydroprocessing according to any embodiment herein may include a cloud point from about 20° C. to about −50° C. The cloud point of the composition may be about 18 C, about 14 C, about 10 C, about 6 C, about 2 C, about −2° C., about −4° C., about −6° C., about −8° C., about −10° C., about −12° C., about −14° C., about −16° C., about −18° C., about −20° C., about −22° C., about −24° C., about −26° C., about −28° C., about −30° C., about −32° C., about −34° C., about −36° C., about −38° C., about −40° C., about −42° C., about −44° C., about −46° C., about −48° C., about −50° C., or any range including and/or in between any two of these values or less than any one of these values or combination of these values.

### Bio-Oil Extraction by Lipid Followed by Hydrotreating of the Solution Containing Extract

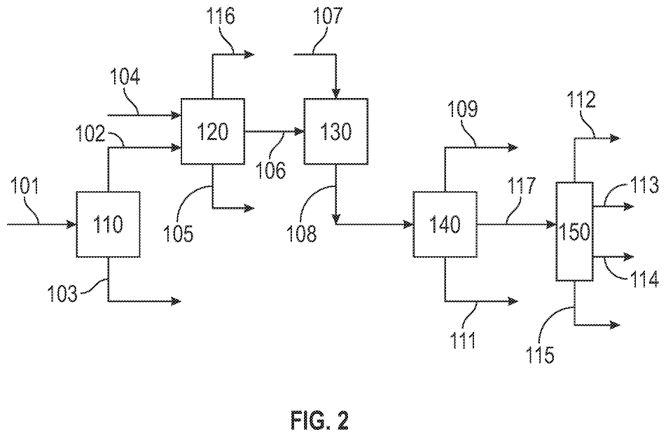

An embodiment of the invention is provided as the block flow diagram in FIG. 2 for describing the present technology. Referring to FIG. 2, lignocellulosic biomass 101 is fed to a convertor 110 for conversion into bio-oil, bio-based gases, and char. The biomass 101 may be agricultural residues (e.g., corn stover), forestry residues (e.g., wood chips, tree thinnings, sawdust, etc.), herbaceous (e.g., switch grass), or woody (e.g., hybrid poplar). The biomass 101 is preferably dried and reduced in size to maximize surface-to-volume ratio for heat and mass transfer during conversion inside the convertor 110. The convertor may be batch or continuous. Continuous convertors include fluidized-bed fast pyrolysis reactors as described above, circulating fluidized bed reactors, auger reactors, ablative reactors, rotary kiln reactors, rotating cone reactors, entrained flow reactors, freefall reactors, and slurry liquefaction reactors. A drum of biomass 101 subjected to slow pyrolysis is an example of a batch convertor. Convertor temperatures and pressures are typically in the range of 350-1000° F. and −10-3000 psig respectively.

A vapor 102 and a char 103 exit the convertor 110. The char may be used to fuel the endothermic biomass conversion reactor 110 or supplied as a co-product (e.g., for soil improvement). In an embodiment of the present technology, the vapor 102 is contacted with lipid feed 104 in contactor 120. In addition to conversion products above their boiling points, vapor 102 also contains liquid droplets of lignin-derived oligomers that exist as aerosols and are present in vapor 102 by entrainment. The bio-oil vapors in vapor stream 102 condenses upon contact with cool lipid stream 104 which enters contactor 120 at a temperature in roughly the 60-300° F. range. In embodiments, the vapor stream 102 is pre-cooled from convertor temperature to a temperature roughly in the 250-500° F. range before it enters contactor 120. Various process coolers known to persons skilled in the art are available for this hot vapor pre-cooling service, including fin fan air coolers and shell and tube exchangers. The shell and tube pre-cooler may utilize an appropriate heat transfer fluid for heat integration with a process stream requiring heating (e.g., a reboiler in the fractionation unit 150 described later herein). In embodiments, vapor stream 102 may also be subjected to an electrostatic precipitator or other means of aerosol collection methods known to persons skilled in the art to impinge aerosols entrained in the stream 102.

The lipid 104 may be a vegetable oil (e.g., soybean oil, canola oil, corn oil, etc.), an animal fat (e.g., tallow, lard, poultry oil, etc.), an oil or grease from food processing or production operations (e.g., used cooking oils, yellow grease, brown grease, etc.), or any combinations or fractions thereof. In embodiments, a derivative of these lipids may be used instead of the lipid itself; for example, fatty acid alkyl esters (biodiesel) derived from a lipid feedstock (such as for example soybean oil or used cooking oil) may be used as lipid 104. In embodiments, lipid 104 may also include water soluble-components, such as water or glycerin, comprising less than 20 wt. % of the lipid 104. In embodiments, the water-soluble components present in lipid 104 are byproducts of biodiesel production and may contain minor impurities such as alcohols, alkali alkoxides, alkali hydroxides, alkali chlorides, alkali citrates, alkali sulfates, enzymes, and other compounds found in biodiesel production which are known to persons skilled in the art.

The contactor 120 generally operates at around 100-300° F. range at a pressure between atmospheric and approximately 600 psig. The contactor may be continuous or batch. Examples include absorption columns (where vapor 102 rises through a packed or tray column where it comes into counter-current contact with lipid 104 flowing down), extraction columns (where condensed bio-oil comes in counter-current contact with lipid), or mixer-settlers (where streams 102 and 104 are mixed via agitation before being allowed to phase separate without agitation). In all cases, the mass ratio of stream 104 to stream 102 varies between around 20:1 and 0.5:1.

A portion of the stream 102 is dissolved in the lipid upon contacting, thus providing three contactor 120 exit streams: (1) an aqueous liquid phase 105, (2) an organic liquid phase 106, and (3) a gas phase 116. The aqueous liquid phase 105 contains mainly water, C2-C4 oxygenates and sugars. In embodiments where stream 104 contains water-soluble components, the aqueous phase 105 also contains the water-soluble components introduced in stream 104. The organic liquid phase 106 contains mainly lipid with 0.1-10% phenolic compounds and lignin-derived oligomers extracted from the bio-oil (i.e., from condensed stream 102). Gas phase 116 includes CO, CO₂, H₂, C1-C2 non-condensable hydrocarbons and oxygenates, and any other processing gases added to converter 110. Stream 116 may be used as fuel gas for the plant. For cases where the CO and H₂ concentrations are higher than 10 mol. %, stream 116 may be used as syngas for production of methanol, oxo alcohols, or Fischer-Tropsch hydrocarbons.

In various embodiments, the aqueous phase 105 is directed to recovery of acetic acid, acetal, hydroxyacetaldehyde, and other chemicals from the water phase. Various separation methods known to persons skilled in the art, including distillation, membrane separation, and mole-sieve adsorption may be employed depending on the purity sought for the chemicals.

The organic liquid phase 106 includes lipids and phenolic bio-oil compounds and has an effective H/C ratio greater than 1.40. The effective H/C ratio of the combined feed may be about 1.45, about 1.50, about 1.55, about 1.60, about 1.65, about 1.70, about 1.75, about 1.80, about 1.85, about 1.90, and about 1.95, or any range including and/or in between any two of these values or combination of these values. For example, the effective H/C ratio of the combined feed of lipid and bio-oil is between about 1.55 and 1.85.

The organic liquid phase 106 is subsequently directed to a hydroprocessing reactor 130. The organic liquid phase has an effective H/C ratio of about 1.55 and 1.85 where the organic liquid is combined with a hydrogen-rich gas 107 and heated to a temperature between 450 and 700° F. under a pressure between 1,000 and 4,000 psig. In embodiments, organic liquid phase 106 may be subjected to a drying step to remove water and other light oxygenates prior to introduction to hydroprocessing reactor 130. In preferred embodiments, the temperature and pressure ranges are around 500-650° F. (WABT) and about 1,600-3,200 psig respectively. The hydroprocessing reactor is preferably a fixed-bed reactor containing catalysts that promote hydrogenation and deoxygenation reactions. Typical catalysts are NiMo, CoMo, and NiW on γ-alumina supports. The preferred catalysts are sulfided molybdenum and tungsten with nickel as promotor. Preferred catalysts Ni:Mo and Ni:W ratios are between 1:3 and 1:5. Preferred catalysts have a mean pore diameter of 180 angstroms or greater. The preferred catalysts (NiMo or NiW) and hydrogen pressures (>1600 psig) ensure that the difficult-to-hydrodeoxygenate planar phenol molecules are first hydrogenated into cyclohexanol and/or cyclexanone (with its more mobile “boat” and “chair” conformations) for better access to the catalyst's hydrodeoxygenation sites.

In embodiments, the hydroprocessing reactor 130 also contains catalysts that promote hydrocracking and isomerization reactions. Typical hydrocracking/isomerization catalysts have silica-alumina supports in either amorphous or crystalline forms. Preferred crystalline supports contain zeolites. The hydrogen-active metals for hydrocracking/isomerization include both noble and base metals such as platinum, platinum/palladium, and nickel/tungsten. Typically, the NiW catalyst is selected if H₂S is expected to be present in the hydrogen-rich gas 107) while the Pt and Pt/Pd catalysts are specified for clean hydrogen-rich gases (i.e., when little or no H₂S or NH₃ is present in the gas). As appreciated by persons skilled in the art, the product of the first hydroprocessing stage using sulfided NiMo or NiW catalyst would need to be stripped of H₂S, H₂O, and NH₃ using steam, nitrogen, hydrogen, or another light gas, before it is fed to the second hydroprocessing stage containing Pt or Pt/Pd catalysts.

When the hydroprocessing reactor 130 is an adiabatic fixed-bed reactor, a hydrocarbon diluent is preferably used to mitigate the temperature rise associated with the exothermic hydrogenation reactions. The hydrocarbon diluent may be a petroleum middle distillate or the partially recycled product of the hydroprocessing reactor (e.g., stream 117 to be described in more detail later herein).

The reactor effluent 108 is subsequently cooled and separated in a separator 140 into a gas product stream 109, a hydrocarbon product stream 117, and a water stream 111. The product gas stream is mainly the unreacted hydrogen and gas-phase byproducts of the hydroprocessing reaction, including CO, CO₂, H₂S, NH₃, and C1-C4 hydrocarbons. In embodiments, a portion of this gas is processed through a membrane to separate the C3+ hydrocarbons for recovery in fractionation unit 150 (to be described later herein). In embodiments, the gas product 109 is treated (e.g., through an amine scrubber) and combined with makeup hydrogen to provide the hydrogen-rich gas 107.

The hydrocarbon product stream 117 may be directed to a fractionation unit 150 where the products are fractionated according to boiling range. A gas cut 112 includes butanes and lighter hydrocarbons for use as a “bio-based LPG” for transportation, heating, and cooking. A gasoline cut 113 in the C5-300° F. boiling range includes aromatic and naphthenic hydrocarbons formed by deoxygenation of mono-phenol compounds from the bio-oil.

A kerosene/diesel cut 114 in the 300-650° F. boiling range includes C10-C24 hydrocarbons. In addition to the paraffins formed from lipid fatty acid chains, the kero/diesel cut includes the naphthenes and aromatics from lignin-derived phenolic dimers/oligomers and hydrocracked products therefrom. The kerosene/diesel cut has an oxygen content of less than 1 wt. % and well-suited for use in compression ignition engines neat or in blends with petroleum and/or biodiesel.

Unlike blends with 100% lipid-based renewable diesel, the kerosene or diesel product of present technology may solubilize biodiesel impurities that have low solubility in 100% lipid-based renewable diesel when blended with more than 7 vol. % biodiesel. In embodiments, a jet fuel distillate is separated from the kerosene/diesel cut 114 for use in aviation turbine fuel.

A bottoms fraction 115 includes the 650 F+ boiling material where most unconverted lignin-derived oligomers are concentrated. These may be recycled back to hydroprocessing reactor 130 or directed to a different hydrocracking reaction (not shown) for conversion into lighter hydrocarbon products for combining with the LPG, gasoline, and kerosene/diesel products described above.

Biomass Liquefaction Assisted by Lipid and/or Lipid Derivatives

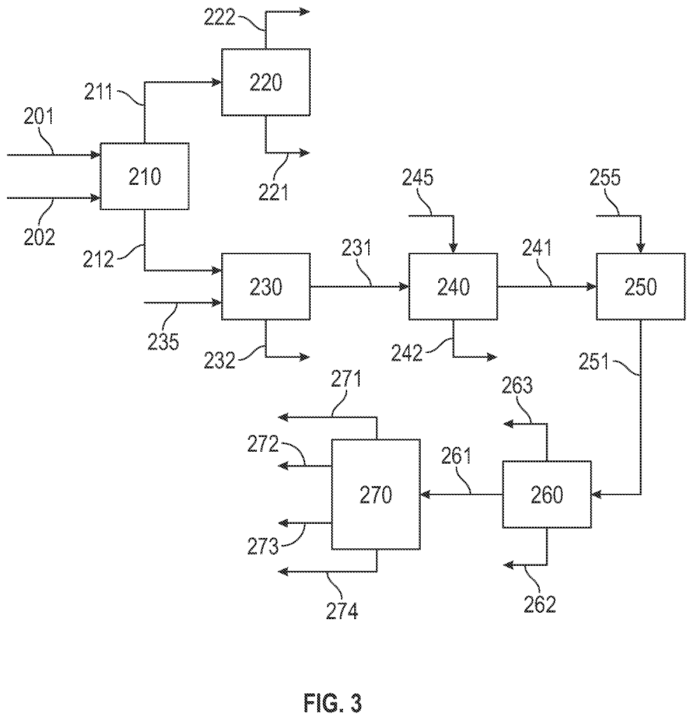

An embodiment of the invention is provided as the block flow diagram in FIG. 3 for describing the present technology. Referring to FIG. 3, lignocellulosic biomass 201 is fed to a convertor 210 for conversion into bio-oil, bio-based gases, and char. The biomass 201 may be agricultural residues (e.g., corn stover), forestry residues (e.g., wood chips, tree thinnings, sawdust, etc.), herbaceous (e.g., switch grass), woody (e.g., hybrid poplar), or mixtures of two or more. In embodiments, the biomass 201 may be comprised of fractionated biomass such that the fractionated biomass is enriched in lignin, cellulose, or holocellulose. In preferred embodiments, the biomass 201 may include extracted lignin, such as lignin produced by the Kraft process, organosolv process, ammonia fiber explosion process, enzymatic hydrolysis process, and other such lignin extraction processes known to persons skilled in the art. The biomass 201 is preferably dried and reduced in size to maximize surface-to-volume ratio for heat and mass transfer during conversion inside the convertor 210. Biomass 201 can be fed to converter 210 by lock-hoppers, rotary air-locks, extruders, pneumatic conveyors, or other means of solid conveyance known to persons skilled in the art.

A solvent 202 is also pumped into converter 210 to facilitate the thermal decomposition of the biomass. Solvent 202 may be co-fed with the biomass 201 as a slurry or pumped as a separate stream into converter 210. In embodiments where solvent 202 and biomass 201 are premixed and co-fed to converter 210, the mixture may be fed to converter 210 by use of centrifugal pumps, pulp pumps, slurry pumps, macerator pumps, extruders, and other means of slurry conveyance known to persons skilled in the art. In all cases, the mass ratio of solvent 202 to biomass 201 is between 20:1 to 0.5:1. Solvent 202 should be chosen primarily for its chemical properties as a solvent with some consideration of practical constraints such as cost, ease of recovery, and volatility. Solvent 202 plays a critical role in the solubilization of the feedstock 201 and desired products such that the products which readily dissolve in the solvent are easier to recover and have reduced participation in undesirable side-reactions. Solvents also directly influence the decomposition of the feedstock such that certain products can be produced at higher yields for solvents in which fully soluble than for solvents in which they are not. In embodiments, solvent 202 can also donate hydrogen to the decomposition products from biomass 201 such that the decomposition products have a higher effective H/C ratio.

In preferred embodiments, solvent 202 is a lipid such as soybean oil or used cooking oil, or a lipid derivative such as alkyl esters produced from transesterification or esterification of lipids (i.e., biodiesel) or paraffinic hydrocarbons produced from hydroprocessed lipids (i.e., renewable paraffinic kerosene, renewable diesel, etc.).

The convertor 210 may be batch or continuous. Continuous convertors include slurry liquefaction reactors, plug flow reactors, and counter-current flow reactors. An agitated drum of biomass 201 mixed with solvent 202 and heated prior to the contents being removed is an example batch convertor. Convertor temperatures and pressures are typically in the range of 350-1000° F. and −10-3000 psig respectively, wherein the pressure is sufficient to maintain the solvent 202 in the sub- or supercritical-liquid phase.

A vapor 211 and a heavy phase 212 exit the convertor 210. Vapor 211 contains conversion products above their boiling points and non-condensable gases fed to converter 210 for processing such as nitrogen, natural gas, or product gases from the present technology that were compressed and recycled. Vapor 211 is directed to separator 220 where the condensable products are recovered. Separator 220 is typically operated at reduced temperatures, such as between about 60-300° F., and the same pressure as converter 210. In embodiments, the vapor stream 211 is cooled from convertor temperature to a temperature in the range of about 60-300° F. before it enters separator 220. Various process coolers known to persons skilled in the art are available for this hot vapor pre-cooling service, including fin fan air coolers and shell and tube exchangers. The shell and tube pre-cooler may utilize an appropriate heat transfer fluid for heat integration with a process stream requiring heating (e.g., a reboiler in the fractionation unit 240 described later herein). In embodiments, vapor stream 211 may also be subjected to an electrostatic precipitator or other means of aerosol collection methods known to persons skilled in the art to impinge aerosols entrained in stream 211. Gas phase 222 includes CO, CO₂, H₂, C1-C2 non-condensable hydrocarbons and oxygenates, and any other processing gases added to converter 210. Stream 222 may be used as fuel gas for the plant. For cases where the CO and H₂ concentrations are higher than 10 mol %, stream 222 may be used as syngas for production of methanol, oxo alcohols, or Fischer-Tropsch hydrocarbons. In some embodiments, stream 222 may be compressed and recycled to converter 210, as described earlier.

Condensate stream 221 contains decomposition products that are below their boiling point at the operating conditions of separator 220. In embodiments, stream 221 typically contains water, light oxygenates such as acetic acid, formic acid, propionic acid, formaldehyde, acetal, acetaldehyde, hydroxyacetaldehyde, and methanol, and any entrained aerosols from converter 210.

In embodiments, the condensate 221 is directed to recovery of acetic acid, formic acid, propionic acid, acetal, hydroxyacetaldehyde, and other chemicals from the water phase. Various separation methods known to persons skilled in the art, including distillation, membrane separation, and mole-sieve adsorption may be employed depending on the purity sought for the chemicals.

The heavy phase 212, comprised of conversion products below their boiling points, solvent, unreacted feedstock, and char, is directed to separator 230 by pumping, gravity, or differential pressure between converter 210 and separator 230. Separator 230 removes solid residue 232, typically unreacted feedstock and char, the heavy liquid 231 which includes high-boiling point liquid products and solvent. The solid residue 232 may be used to fuel the endothermic biomass conversion reactor 210 or supplied as a co-product (e.g., for soil improvement). Separator 230 may be at least one of a settling tank, hydrocyclone, centrifuge, sintered metal filters, bag filters, packed bed filters, pressure leaf filters, or other means of solid-liquid separation known to those skilled in the art. In preferred embodiments, separator 230 is a settling tank followed by a filtration device such as those listed above. In embodiments, a filter media, such as diatomaceous earth, is used to enhance removal of solid residue 232 from heavy liquid 231. Separator 230 may operate at temperatures below that of converter 210, but not at temperatures below about 200° F. to maintain heavy phase 212 with a viscosity low enough to facilitate removal of solid residue 232. In embodiments, separator 230 operates at temperatures ranging from 200-400° F. In embodiments, a solids removal additive 235, such as an alcohol or hydrocarbon, may be added to separator 230 to aid in solids removal by further reducing the viscosity of heavy phase 212. In embodiments, the solids removal additive 235 is a hydrocarbon produced from hydroprocessing of lipids and pyrolyzates. In embodiments, the solids removal additive 235 is renewable paraffinic naphtha produced from hydroprocessing of lipids and pyrolyzates. The solids removal additive 235 primarily leaves separator 230 with heavy liquid 231.

Heavy liquid 231 is directed to contactor 240 where it is contacted with washing stream 245. The contactor 240 generally operates at around 100-300° F. and at a pressure between about 1 and 500 psig. The contactor may be continuous or batch. Examples include absorption columns, extraction columns, contacting centrifuges, or mixer-settlers. In all cases, the mass ratio of stream 231 to stream 245 varies between about 20:1 and 1:1.

A portion of the stream 231 is dissolved in the washing stream 245 upon contacting, thus providing two contactor 240 exit streams: an aqueous liquid phase 242, and an organic liquid phase 241. The washing liquid 245 is a polar liquid suitable for washing out high-boiling point polar products, primarily from the decomposition of polysaccharides, such as levoglucosan, levoglucosenone, cellobiosan, maltosan, furfural, 5-methyl furfural, dimethoxytetrahydrofuran, and other sugars and anhydrosugars. In embodiments, the washing liquid 245 is one with a dielectric constant greater than about 10.0. In embodiments, the washing liquid 245 is primarily water. In embodiments, the washing liquid 245 primarily glycerol. In embodiments, the washing liquid 245 is a mixture of water and glycerol. In embodiments, the washing liquid 245 is a byproduct of biodiesel production containing primarily water and glycerol, and may contain minor impurities such as alcohols, alkali alkoxides, alkali hydroxides, alkali chlorides, alkali citrates, alkali sulfates, enzymes, and other compounds found in biodiesel production which are known to persons skilled in the art. In embodiments, condensate 221 is used to make up a portion or all of washing liquid 245.

In embodiments, aqueous phase 242 can be combined with condensate 221 to form a blended composition of aqueous phase 242 for subsequent processing. In embodiments, the aqueous phase 242 is directed to recovery of oligo- and monosaccharides and anhydrosugars. Various separation methods known to persons skilled in the art, including distillation, membrane separation, and mole-sieve adsorption may be employed depending on the purity sought for the chemicals. In embodiments, aqueous phase 242 is suitable for anaerobic or aerobic digestion to produce biogas. In embodiments, aqueous phase 242 is suitable for fermentation to produce bio-alcohols.

The organic liquid phase 241 contains mainly solvent 201 and solids removal additive 235 with phenolic compounds and soluble lignin-derived oligomers produced from biomass 201.

The organic liquid phase 241 comprising solvent, solids removal additive, and phenolic bio-oil compounds has an effective H/C ratio greater than 1.40. The effective H/C ratio of the organic liquid phase 241 may be about 1.45, about 1.50, about 1.55, about 1.60, about 1.65, about 1.70, about 1.75, about 1.80, about 1.85, about 1.90, and about 1.95, or any range including and/or in between any two of these values. For example, the effective H/C ratio of the combined feed of lipid and bio-oil is between 1.55 and 1.85.

The organic liquid phase 241 is subsequently directed to a hydroprocessing reactor 250 where the organic liquid is combined with a hydrogen-rich gas 255 and heated to a temperature between about 450 and 700° F. under a pressure between 1,000 and 4,000 psig. In embodiments, organic liquid phase 241 may be subjected to a drying step to remove water and other light oxygenates prior to introduction to hydroprocessing reactor 250. In preferred embodiments, the temperature and pressure ranges are around 500-650° F. (WABT) and about 1,600-3,200 psig, respectively. The hydroprocessing reactor is preferably a fixed-bed reactor containing catalysts that promote hydrogenation and deoxygenation reactions. Typical catalysts are NiMo, CoMo, and NiW on γ-alumina supports. The preferred catalysts are sulfided molybdenum and tungsten with nickel as promotor. Preferred catalysts Ni:Mo and Ni:W ratios are between 1:3 and 1:5. Preferred catalysts have a mean pore diameter of 180 angstroms or greater. The preferred catalysts (NiMo or NiW) and hydrogen pressures (>1600 psig) ensure that the difficult-to-hydrodeoxygenate planar phenol molecules are first hydrogenated into cyclohexanol and/or cyclohexanone (with its more mobile “boat” and “chair” conformations) for better access to the catalyst's hydrodeoxygenation sites.

In embodiments, the hydroprocessing reactor 250 also contains catalysts that promote hydrocracking and isomerization reactions. Typical hydrocracking/isomerization catalysts have silica-alumina supports in either amorphous or crystalline forms. Preferred crystalline supports contain zeolites. The hydrogen-active metals for hydrocracking/isomerization include both noble and base metals such as platinum, platinum/palladium, and nickel/tungsten. Typically, the NiW catalyst is selected if H₂S is expected to be present in the hydrogen-rich gas 255) while the Pt and Pt/Pd catalysts are specified for clean hydrogen-rich gases (i.e., when little or no H₂S or NH₃ is present in the gas). As appreciated by persons skilled in the art, the product of the first hydroprocessing stage using sulfided NiMo or NiW catalyst would need to be stripped of H₂S, H₂O, and NH₃ using steam, nitrogen, hydrogen, or another light gas, before it is fed to the second hydroprocessing stage containing Pt or Pt/Pd catalysts.

When the hydroprocessing reactor 250 is an adiabatic fixed-bed reactor, a hydrocarbon diluent is preferably used to mitigate the temperature rise associated with the exothermic hydrogenation reactions. The hydrocarbon diluent may be a petroleum middle distillate or the partially recycled product of the hydroprocessing reactor (e.g., stream 261 to be described in more detail later herein).

The reactor effluent 251 is subsequently cooled and separated by separator 260 into a gas product stream 263, a hydrocarbon product stream 261, and a water stream 262. In embodiments, water stream 262 may be recycled back to comprise all or a portion of washing liquid 245. The product gas stream is mainly the unreacted hydrogen and gas-phase byproducts of the hydroprocessing reaction, including CO, CO₂, H₂S, NH₃, and C1-C4 hydrocarbons. In embodiments, a portion of this gas is processed through a membrane to separate the C3+ hydrocarbons for recovery in fractionation unit 270 (to be described later herein). In embodiments, the gas product 263 is treated (e.g., through an amine scrubber) and combined with makeup hydrogen to provide the hydrogen-rich gas 255.

The hydrocarbon product stream 261 may be directed to a fractionation unit 270 where the products are fractionated according to boiling range. A gas cut 271 includes butanes and lighter hydrocarbons for use as a “bio-based LPG” for transportation, heating, and cooking. A gasoline cut 272 in the C5-300 F boiling range includes aromatic and naphthenic hydrocarbons formed by deoxygenation of mono-phenol compounds from the bio-oil. Gasoline cut 272 may be recycled back to include all or a portion of solids removal additive 235.

A kerosene/diesel cut 273 in the 300-650 F boiling range includes C10-C24 hydrocarbons. In addition to the paraffins formed from lipid fatty acid chains, the kero/diesel cut includes the naphthenes and aromatics from lignin-derived phenolic dimers/oligomers and hydrocracked products therefrom. The kerosene/diesel cut has an oxygen content of less than 1 wt. % and is well-suited for use in compression ignition engines as a neat fuel or in blends with petroleum and/or biodiesel.

Unlike blends with 100% lipid-based renewable diesel, the kerosene/diesel product of present technology may be blended with more than 7% biodiesel that has impurities having low solubility in 100% lipid-based renewable diesel. In embodiments, a jet fuel distillate is separated from the kerosene/diesel cut 273 for use in an aviation turbine fuel.

A bottoms fraction 274 includes the 650 F+ boiling material where most unconverted lignin-derived oligomers are concentrated. These may be recycled back to hydroprocessing reactor 250 or directed to a different hydrocracking reaction (not shown) for conversion into lighter hydrocarbon products for combining with the LPG, gasoline, and kerosene/diesel products described above. Bottoms fraction 274 may also be recycled back to comprise all or a portion of solvent 202 or it may be sold as a residual fuel oil product that contains renewable content.

The present technology, thus generally described, will be understood more readily by reference to the following example, which is provided by way of illustration and is not intended to be limiting of the present technology.

### EXAMPLES

The following examples depicts three experiments that were conducted to determine the feasibility and utility of the present invention.

All three experiments were conducted in a 1-liter Autoclave bottom-drain reactor equipped with a Robinson-Mahoney stationary catalyst basket. The catalyst basket was loaded with a commercially available NiMo fixed bed hydrotreating catalyst that was sulfided prior to loading. The annulus of the catalyst basket contained a multi-impeller agitator, a submerged gas sparge tube positioned at the bottom of the catalyst basket for the addition of hydrogen, an internal sample port positioned at the bottom of the catalyst basket, a liquid feed charge tube positioned at the top of the catalyst basket, a thermowell, and a gas outlet port. The gas outlet port was connected to a water-cooled heat exchanger that was used to condense components with a dew point greater than ˜100° F.

Pyrolysis oil produced from the autothermal pyrolysis of softwood was used to exemplify the present invention. The pyrolysis oil was collected in four stage-fractions. Stage fraction 1 and Stage Fraction 2, referred to herein as the “heavy ends” or “bio-oil”, were combined in approximately the same mass ratio as they were produced from the pyrolysis experiments; this bio-oil was used as the reactive feed for this experimentation. The heavy ends were used because they contain most of the carbohydrate dehydration products, phenolic oligomers, and phenolic monomers within the appropriate carbon number range produce naphtha and distillate range hydrocarbons. Further details of the pyrolysis process used to produce the bio-oil can be found elsewhere (Sean A. Rollag, 2020).

Food-grade canola oil was used as the reactive feed for the control trial (baseline). Reactive feed for the blend testing was a mixture of ˜60 wt. % food-grade canola oil and ˜40 wt. % bio-oil heavy ends. The final trial was conducted with 100% bio-oil heavy ends.

Octadecane, normal-paraffinic solvent, was added to the reactor such that the entire catalyst basket was submerged. A sulfiding agent, TBPS-454, was also dosed to the reactor at sufficient levels to maintain catalyst activity during the reaction. In each experiment, the reactive feed was added to the reactor to achieve a solvent to oil dilution of about 3:1 by volume.

Hydrogen was supplied continuously throughout the duration of each experiment. The minimum hydrogen flowrate was calculated based on the reactive feed oxygen content and degree of unsaturation. The flowrate used was at least two times greater than the stoichiometric requirement to completely deoxygenate and hydrogenated the reactive feed through the duration of the 90 minutes experiment. Thus, the higher oxygen content of the bio-oil led to a higher hydrogen requirement than that of the canola oil. The flow rate used for the 40 wt. % bio-oil test was approximately twice that of the baseline and the 100% bio-oil test required nearly 3.2 times the amount of hydrogen.

After loading the reactor with the liquid inputs, the reactor was purged with nitrogen, pressurized to about 1000 psig, and heated to 640° F. Once the reactor temperature reached 640° F. it was further pressurized to 1660 psig with 99.99% hydrogen and continuous hydrogen flow was initiated, indicating “time zero” for the reaction cycle.

Water vapor and other compounds that were volatile at the reactor conditions were continuously flushed from the reactor. Those that were condensable at approximately 100° F. were condensed at the heat exchanger described earlier. Samples were also collected directly from the reactor during the experiments through the internal sample port. All liquid samples were cooled to ˜100° F. prior to collection to help prevent loss of volatile species.

The reactor was shut down after the desired cycle time or extent of conversion was reached. Shut down was accomplished by shutting off the hydrogen supply and reducing the temperature setpoint to 140° F. After reaching 140° F. and completing a thorough nitrogen purge the reactor was completely emptied via a bottom drain port. Nitrogen pressure of ˜50 psig was maintained while the reactor was drained. Fresh solvent, sulfiding agent, and fresh reactive feed were charged into the reactor for the subsequent run only after all liquid from the prior run had been drained. One catalyst load was used for all reactions described in this example.

All experiments achieved a high level of reactant conversion as indicated by the measured Total Acid Number (TAN) value (according to ASTM D664), as shown below in Error! Reference source not found. The baseline experiment proceeded normally with no signs of catalyst activity reduction nor reactor fouling. Similarly, the 40% bio-oil in canola oil experiment proceeded in a similar fashion as the baseline experiment, achieving full conversion, with no signs of catalyst activity reduction nor reactor fouling. Conversely, the reactor product from the 100% bio-oil case had a product TAN value that was nearly four times higher than was observed from the two other experiments. The elevated TAN is a primary indication of reduced hydrotreating performance through reduced catalyst activity and/or fouling by the coking. Furthermore, while attempting to sample the reactor contents, it was discovered that the reactor content sample port had plugged. Due to the plugging, liquid samples couldn't be obtained throughout the experiment. Therefore, the experiment was allowed to run to completion and the liquid reaction products were removed at that time through the vessel bottom drain.

Following the 100% bio-oil experiment, upon opening the reactor after completion of the experiment the reactor was found to contain a significant amount of coke buildup. No coke formation was observed in the experiments that were conducted with canola oil or the 40 wt. % bio-oil experiment. Hu et al. (Xun Hu, 2020) summarized many of the latest trials among the literature for hydrodeoxygenation of bio-oil. Although some differences were observed between different catalysts and operating conditions, like the 100% bio-oil experiment discussed here, biomass derived bio-oil was found to form a significant amount of coke in each example. The carbohydrate derived material was observed to dehydrate, decarboxylate, and decarbonylate to produce unsaturated intermediate compounds that combined and polymerized to form aromatics that further polymerized to form coke. Similarly, the lignin derived compounds that were already aromatic in nature further condensed to form multicyclic aromatics that continued to polymerize and form coke.

As summarized by Hu et al. (Xun Hu, 2020), several researchers also attempted using water and low molecular weight alcohols as solvents for the bio-oil. Some of the solvents helped reduce the coking rate, however, the solvents used are not likely to be practical to use at an industrial scale. Using lipids as the solvent that are already to be used for production of renewable diesel as discussed in the present invention makes the process more feasible.

Coke formation was observed to significantly reduce the liquid yield from reactive feed to the point that it would not be feasible to process 100% bio-oil in this manner. As shown in Error! Reference source not found.4, the 100% canola oil sample resulted in a total liquid yield of around 85%. Adding 40 wt % bio-oil to the canola decreased the total liquid yield to around 68% as expected due to the higher oxygen content of the bio-oil. Assuming the liquid yield would follow a linear trend, the 100% bio-oil experiment would be expected to produce around 40% liquid. However, the yield was measured to be only 15% due to the additional coke formation.

Coke formation during the 100% bio-oil case was such that it would be reasonably expected to quickly foul the catalyst and internals of a fixed bed system, thereby quickly reducing the life of the catalyst bed and make the process infeasible at an industrial scale. In contrast, blending the bio-oil with canola oil (at 40% as exemplified herein) demonstrates a substantially favorable improvement in both final conversion and reduction of coke formation.

The product material from the three experiments (the 100% canola oil, 40% bio-oil/60% canola oil, and 100% bio-oil) were observed. Displaying the products side-by-side revealed significant visual differences associated with the product of the 100% bio-oil reaction. The product material for 100% canola oil and 40% bio-oil/60% canola oil were generally clear and similar in appearance. In contrast, the color of the 100% bio-oil product material was yellow. The color bodies of the 100% bio-oil product material and significant quantities of insoluble material are indicative of non-paraffinic products.

It will thus be seen according to the present invention a highly advantageous lipid assisted conversion for hydrocarbon fuels and more specifically to fuels having a renewable content has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products

1. A method for converting a bio-oil derived from lignocellulose biomass to a hydrocarbon fuel or fuel blendstock comprising the steps of;
(a) combining the bio-oil with a lipid to produce a combined feed;
(b) directing the combined feed to a hydroprocessing reactor to produce a reactor effluent;
(c) separating the reactor effluent into a hydrocarbon, a gas, and a water stream; and
(d) fractionating the hydrocarbon into a gasoline cut and a kerosene/diesel cut;
wherein the combined feed has a lipid content between about 16 vol. % and about 90 vol. % and the kerosene/diesel cut has less than 0.1 wt. % oxygen.

2. The method of claim 1, wherein the combined feed has an effective H/C ratio between 1.4 and 1.8.

3. The method of claim 1, further comprising producing the bio-oil by at least one of fast pyrolysis, hydrothermal liquefaction, or solvent liquefaction or combinations thereof.

4. The method of claim 1, wherein the lipid comprises animal fats, vegetable oils, grease, or a mixture thereof.

5. The method of claim 1, wherein the lipid comprises between about 5 wt. % and 95 wt. % free fatty acids.

6. The method of claim 1, wherein the hydroprocessing reactor includes at least one of hydrotreating, hydrogenation, hydrocracking and hydroisomerization.

7. The method of claim 1, wherein the hydroprocessing reactor operates at a WABT between about 550° F. and 690° F., and a pressure between about 1000 psig and 3,000 psig.

8. The method of claim 1, wherein the hydorprocessing reactor contains catalysts comprising sulfided molybdenum, tungsten or a combination thereof.

9. The method of claim 1, wherein the kerosene/diesel cut has a cetane number greater than or equal to 40.

10. The method of claim 1, further comprising blending the kerosene/diesel cut with biodiesel.

11. The method of claim 1, further comprising fractionating a crude bio-oil to produce the bio-oil prior to combining the bio-oil with the lipid in step (a).

12. The method of claim 11, wherein the bio-oil has been fractionated according to a boiling point greater than about 200° F.

13. The method of claim 11, wherein the bio-oil has been fractionated according to a boiling point greater than 250° F.

14. The method of claim 11, wherein the bio-oil has been fractionated according to a boiling point greater than 300° F.

15. The method of claim 11, further comprising fractionating the bio-oil according to solubility in water such that substantially all water-soluble compounds have been removed and the bio-oil is substantially water-insoluble prior to being combined with the lipid in step (a).

16. The method of claim 3, further comprising producing the bio-oil exclusively from fluidized bed fast pyrolysis.

17. The method of claim 1, further comprising producing the bio-oil exclusively from solvent liquefaction.

18. The method of claim 17 wherein the solvent liquefaction process utilizes lipids or lipid derivatives as a portion or all of the primary reaction solvent.

19. A method for converting a bio-oil derived from lignocellulosic biomass to a fuel or fuel blendstock comprising the steps of:
(a) contacting the bio-oil with a lipid or lipid derivative to form an organic phase comprising phenolic compounds and an aqueous phase;
(b) separating the organic phase from the aqueous phase;
(c) subjecting the organic phase to hydrogenation and deoxygenation in a hydroprocessing reactor to produce a hydrocarbon product, a gas product, and water; and
(d) fractionating the hydroprocessing reactor hydrocarbon product into fuel products comprising gasoline and kerosene/diesel.

20. A method for converting a crude bio-oil derived from lignocellulosic biomass to a fuel or fuel blendstock comprising the steps of:
(a) fractionating the crude bio-oil according to boiling point or solubility in water to produce a refined bio-oil;
(b) contacting the refined bio-oil with a lipid or lipid derivative to form an organic phase comprising phenolic compounds and an aqueous phase;
(b) separating the organic phase from the aqueous phase;
(c) subjecting the organic phase to hydrogenation and deoxygenation in a hydroprocessing reactor to produce a hydrocarbon product, a gas product, and water; and
(d) fractionating the hydroprocessing reactor hydrocarbon product into fuel products comprising a gasoline cut and a kerosene/diesel cut;
wherein the combined feed has a lipid content between about 16 vol. % and about 90 vol. % and the kerosene/diesel cut has less than 0.1 wt. % oxygen.
